(19) United States
(12) Patent Application Publication
(10) Pub. No.: US 2010/0074359 A1
(43) Pub. Date: Mar. 25, 2010

(54) Base Station and Communication Method

(75) Inventors: Hironobu Tanigawa, Yokohama-shi (JP); Yasuhiro Nakamura, Yokohama-shi (JP); Nobuaki Takamatsu, Yokohama-shi (JP)

Correspondence Address: HOGAN & HARTSON L.L.P., 1999 AVENUE OF THE STARS, SUITE 1400, LOS ANGELES, CA, 90067, US

(73) Assignee: KYOCERA CORPORATION, Kyoto-shi, Kyoto (JP)

(21) Appl. No.: 12/517,023

(22) PCT Filed: Nov. 15, 2007
(86) PCT No.: PCT/JP2007/072212

§ 371 Date: Oct. 9, 2009

(30) Foreign Application Priority Data
Nov. 29, 2006 (JP) 2006-322542

(51) Int. Cl. H04L 1/02; H04W 72/00

(52) U.S. Cl. 375/267; 370/329; 455/450

(57) ABSTRACT

Improvement in utilization efficiency of traffic channels and voice quality in an OFDMA scheme is accomplished. A base station communicating which mobile stations by an OFDMA scheme using subchannels includes: a channel assigning unit 109a which assigns subchannels for communication to the mobile stations; and a call type acquiring unit 109b which acquires a type of a call as a communication object, wherein the channel assigning unit 109a changes a subchannel assignment procedure for assigning the subchannels to the mobile stations according to the acquired type of the call.

### TECHNICAL FIELD

The present invention relates to a channel assignment technique in communication using an OFDMA (Orthogonal Frequency Division Multiple Access) scheme.

### BACKGROUND ART

As known well, an OFDMA is a technique of implementing a multiplexing access by sharing all sub carriers orthogonal to each other with all wireless mobile stations PS, while setting any of sub carriers as one group, and adaptively assigning one or more groups to respective wireless mobile stations PS. In a communication system as a background of the present invention, a Time Division Multiple Access (TDMA) technique and a Time Division Duplex (TDD) technique are additionally combined with the OFDMA technique. Specifically, as TDD, each group is divided into an uplink and a downlink in a time axis direction, and further, each of the uplink and the downlink is divided into four TDMA slots. One unit obtained by dividing each group into the TDMA slots in the time axis direction is called a subchannel.

FIG. 6 shows relations of frequency, TDMA slots, and subchannels in the above-mentioned communication system. Here, the vertical axis represents frequency, and the horizontal axis represents time. As shown in FIG. 6, 112 subchannels in total obtained by multiplying 28 units in the frequency axis direction by four units (four slots) in the time axis direction are assigned for each of the uplink and the downlink. As shown in FIG. 6, the subchannels (number 1 in FIG. 6) of the first stage in the frequency axis direction among the entire subchannels are used as control channels (CCH) and the other subchannels are used as traffic channels. One or more traffic subchannels among the entire traffic subchannels (in this case, 108 subchannels obtained by 27 units other than CCH×4 slots) belonging to each of the uplink and the downlink are assigned to a base station CS and a wireless mobile station PS which wirelessly communicate with each other. The same traffic subchannels are assigned to the uplink and downlink traffic subchannels as communication channels.

The traffic subchannels include anchor subchannels (ASCH) and extra subchannels (ESCH). The anchor subchannel is a subchannel which is used to notify the respective mobile stations of subchannels assigned to the mobile stations and which is used to negotiate whether data has been correctly exchanged in a re-transmission control between the base station and the mobile stations. The extra subchannel is a subchannel for transmitting actually-used data and plural extra subchannels can be assigned to one mobile station. In this case, as the more number of assigned extra subchannels becomes more, the bandwidth becomes wider, thereby enabling a faster communication.

In the communication system, the extra subchannels are dynamically assigned to accomplish effective use of the traffic channels. In dynamically assigning the extra subchannels, MAP information indicating which subchannel should be assigned to a mobile station is notified from a base station to the mobile station using the anchor subchannel in advance.

In the communication system, the anchor subchannel is allowed to dynamically assign the extra subchannels according to the data amount of a communication object at the time of a communication. Accordingly, when communication data does not temporarily exist, only the anchor subchannel is assigned to the mobile station as a communication target and the extra subchannels released from assignment are used for communications of other mobile stations. In this way, by dynamically assigning the extra subchannels, the effective use of the traffic channels is accomplished.

### DISCLOSURE OF THE INVENTION

### Problem that the Invention is to Solve

In communication of data having a burst characteristic such a voice, when no voice data to be transmitted exists, assignment of extra subchannels is basically not necessary. However, a voice communication does not permit any delay in nature and the extra subchannels are necessary to be secured to guarantee the real time property even when no voice data to be transmitted exists. Accordingly, since the extra subchannels are necessary to be always assigned in addition to the anchor subchannel, the utilization efficiency of the subchannels is deteriorated.

In the communication system, the carriers are not sensed at the time of assigning the extra subchannels. Accordingly, the extra subchannels interfering with other stations may be assigned to the voice communication. In a data communication, even when the communication quality is deteriorated due to the interference, the communication quality can be guaranteed by re-transmission. However, in the voice communication emphasizing the real time property, the voice quality deteriorates.

As described above, the dynamic assignment of the extra subchannels allows the effective use of the subchannels, but may be not the best method depending on the type of communication.

### Means for Solving the Problem

A base station according to the present invention, which communicates with mobile stations by an OFDMA scheme using subchannels includes: a channel assigning unit which assigns subchannels for communication to the mobile stations; and a type acquiring unit which acquires a type of a call as a communication object, wherein the channel assigning unit changes a subchannel assignment procedure for assigning the subchannels to the mobile stations according to the acquired type of a call. A communication method according to the present invention for performing a communication between mobile stations and a base station by an OFDMA scheme using subchannels includes: a step of acquiring a type of a call as a communication object; and a channel assigning step of changing a subchannel assignment procedure for assigning the subchannels to the mobile stations according to the acquired type of the call.

According to the above-mentioned configuration, it is possible to optimally assign the subchannels according to the type of a call by changing the subchannel assignment procedure according to the type of a call. For example, when the type of a call is a voice communication, the MAP information necessary for the dynamic assignment is not required while assigning only the subchannel used in the voice communication. Accordingly, it is possible to assign the subchannel assigned as the anchor subchannel for the MAP information as a subchannel used in the voice communication or a subchannel used by another user. Since the voice communication can be made by only one subchannel, it is possible to improve the utilization efficiency of the traffic channels. By fixedly assigning the subchannels to the voice communication in advance, the subchannel interfering with another station is not assigned, which can occur in the dynamic assignment, thereby not causing the deterioration in voice quality.

### BRIEF DESCRIPTION OF THE DRAWINGS

FIG. 1 is a diagram illustrating a configuration of a base station according to an embodiment of the present invention.

FIG. 2 is a diagram illustrating a configuration of a communication system to which the base station according to the embodiment of the invention is used.

FIG. 3 is a diagram illustrating a communication sequence (a calling party).

FIG. 4 is a diagram illustrating a communication sequence (a called party).

FIG. 5 is a diagram illustrating a frame format of a subchannel.

FIG. 6 is a diagram illustrating an OFDMA frame format.

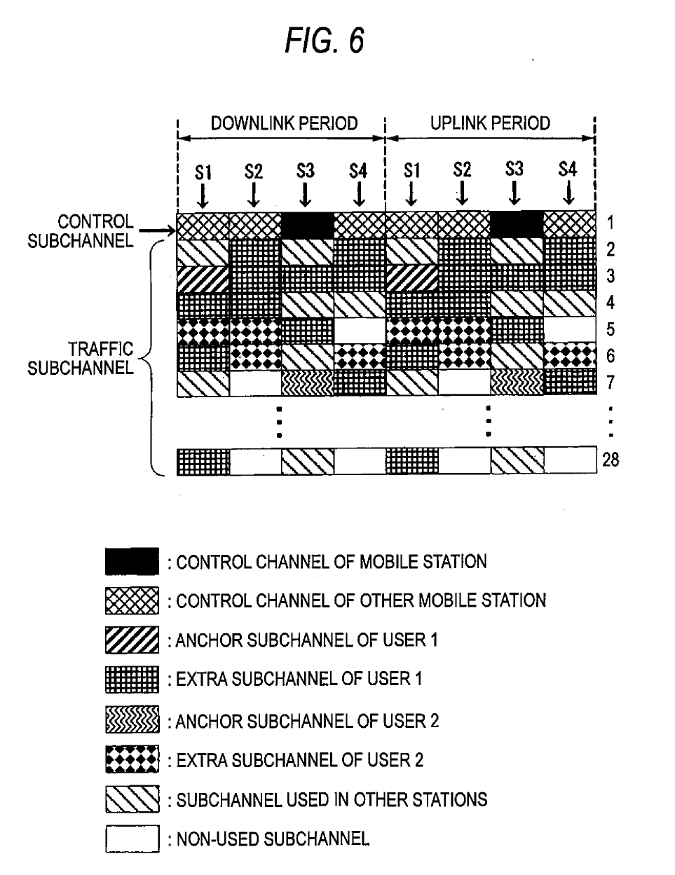

### DESCRIPTION OF REFERENCE NUMERALS AND SIGNS

100: BASE STATION

101: WIRELESS COMMUNICATION UNIT

103: SIGNAL PROCESSING UNIT

105: MODULATION AND DEMODULATION UNIT

107: EXTERNAL IF UNIT

109: CONTROL UNIT

109a: CHANNEL ASSIGNING UNIT

109b: CALL TYPE ACQUIRING UNIT

111: STORAGE UNIT

### BEST MODE FOR CARRYING OUT THE INVENTION

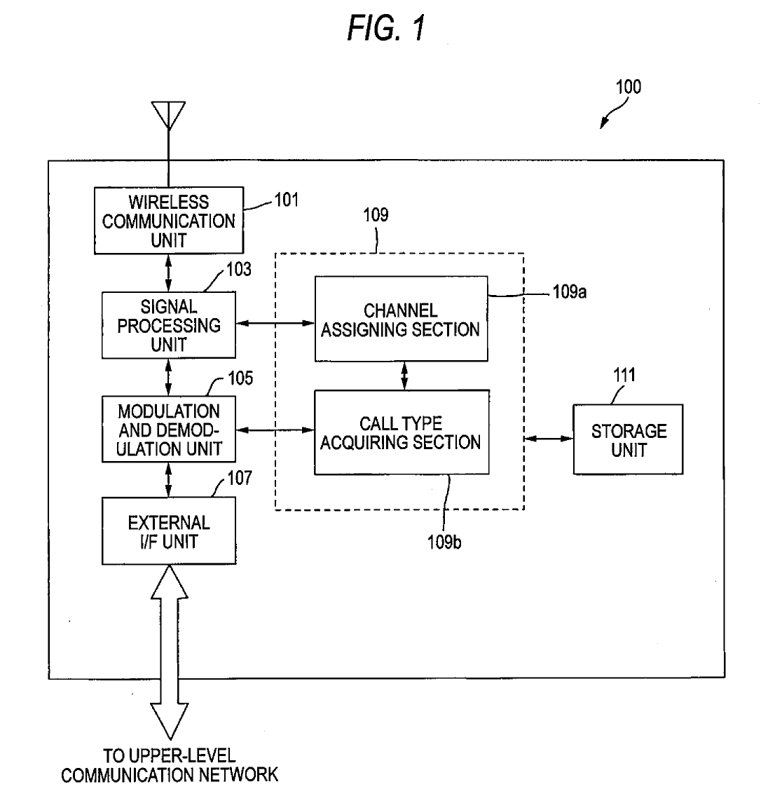

FIG. 1 is a diagram illustrating a configuration of a base station according to an embodiment of the present invention. A base station 100 includes a wireless communication unit 101, a signal processing unit 103, a modulation and demodulation unit 105, an external IF unit 107 for connection to an upper-level communication network, a control unit 109, and a storage unit 111 which stores control content of the control unit 109.

The control unit 109 includes a channel assigning unit 109a which collects and assigns plural carriers in the OFDMA scheme as a subchannel for transmitting data to respective mobile stations belonging to the base station and a call type acquiring unit 109b which acquires a type of a call as a communication object from the modulation and demodulation unit 105. The channel assigning unit 109a determines that one subchannel (circuit switching subchannel CSCH) should be assigned when the type of the call is a voice communication or two subchannels (an anchor subchannel and an extra subchannel) should be assigned when the type of a call is a data communication according to the type of a call and notifies the determination result to the signal processing unit 103, in a procedure for assigning the subchannels to the respective mobile stations belonging to the base station. The channel assigning unit 109a fixedly assigns the subchannel (CSCH) used in the voice communication to the mobile station and does not change the assigned subchannel (CSCH) from the start of the communication to the end thereof, when the acquired type of a call is the voice communication.

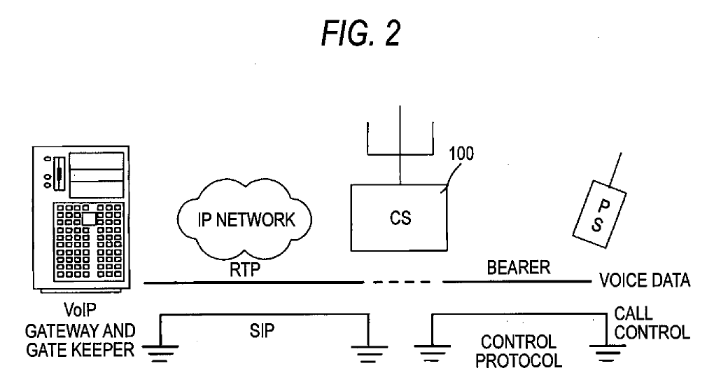

FIG. 2 is a diagram illustrating a configuration of a communication system using the base station according to the embodiment of the present invention. The base station 100 is connected to an IP network and the base station 100 and a mobile station PS are wirelessly connected to each other in a circuit switching manner. The call control in a wireless part uses a control protocol and is terminated in the base station 100. The call control at a level higher than the base station 100 uses a session initiation protocol (SIP). For voice data, a subchannel payload is used in an ADPCM bearer transmission in the wireless part and a real time transport protocol (RTP) is used in an IP network.

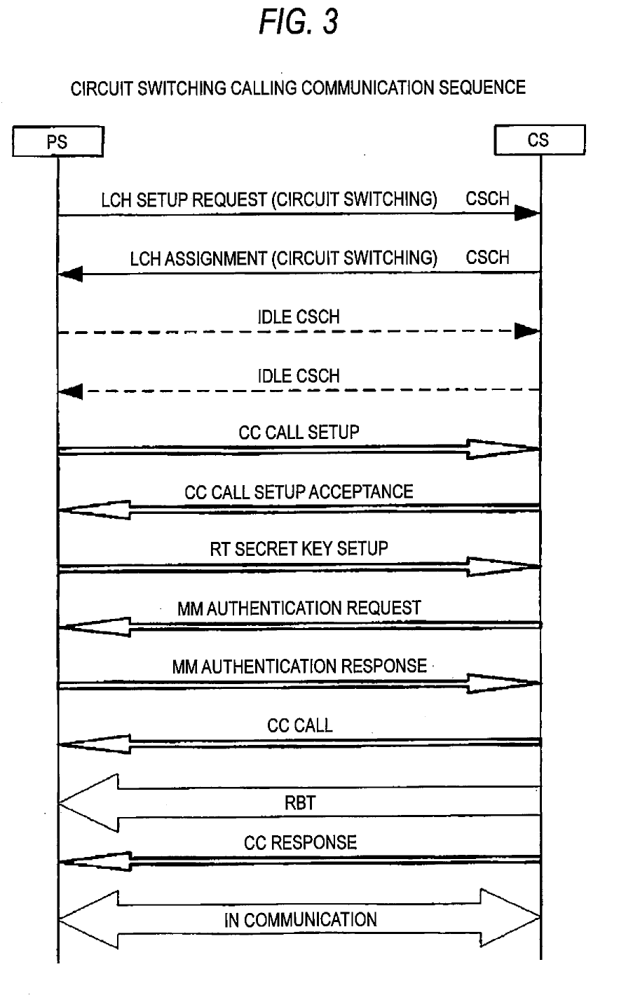

FIG. 3 is a diagram illustrating a communication sequence of a calling party. A mobile station PS sends a link channel (LCH) setup request to the base station CS. A circuit switching scheme or a packet switching scheme can be selected as the link scheme. When the communication object is voice data, a circuit switching subchannel CSCH is sent to request for the circuit switching scheme. The base station CS returns the circuit switching subchannel CSCH to the mobile station PS and notifies an assigned subchannel number to the mobile station PS (assignment of LCH). The mobile station PS sends an idle CSCH through the assigned subchannel. The base station CS confirms an uplink idle CSCH and returns an idle CSCH. The mobile station PS recognizes that the link is set up in the circuit switching scheme by a downlink CSCH, and enters a service channel setup phase.

The mobile station PS transmits a layer 3 message through the circuit switching subchannel CSCH to request for a “call setup CC.” The base station CS sends a SIP session initiation request to the network and returns a “call setup acceptance message CC” as a response message to the mobile station PS when the request is accepted.

The mobile station PS notifies a secret key used for link encryption in a “secret key setup RT.” The base station CS notifies an authentication random number generated by an authentication server to the mobile station PS in an “authentication request MM.” The mobile station PS notifies the calculation result using the authentication random number and its own authentication key to the base station in an “authentication response MM.” The authentication server determines whether the received calculation result is correct, and performs the calling sequence when the calculation result is correct, and performs a release sequence when the calculation result is incorrect.

The base station CS transmits a “call CC” to the mobile station PS to notify the calling when receiving the called state in the SIP. The base station CS sends a “response CC” to the mobile station PS when receiving a called user's response in the SIP. The base station releases the call when receiving a message indicating that the call is not accepted in the calling sequence.

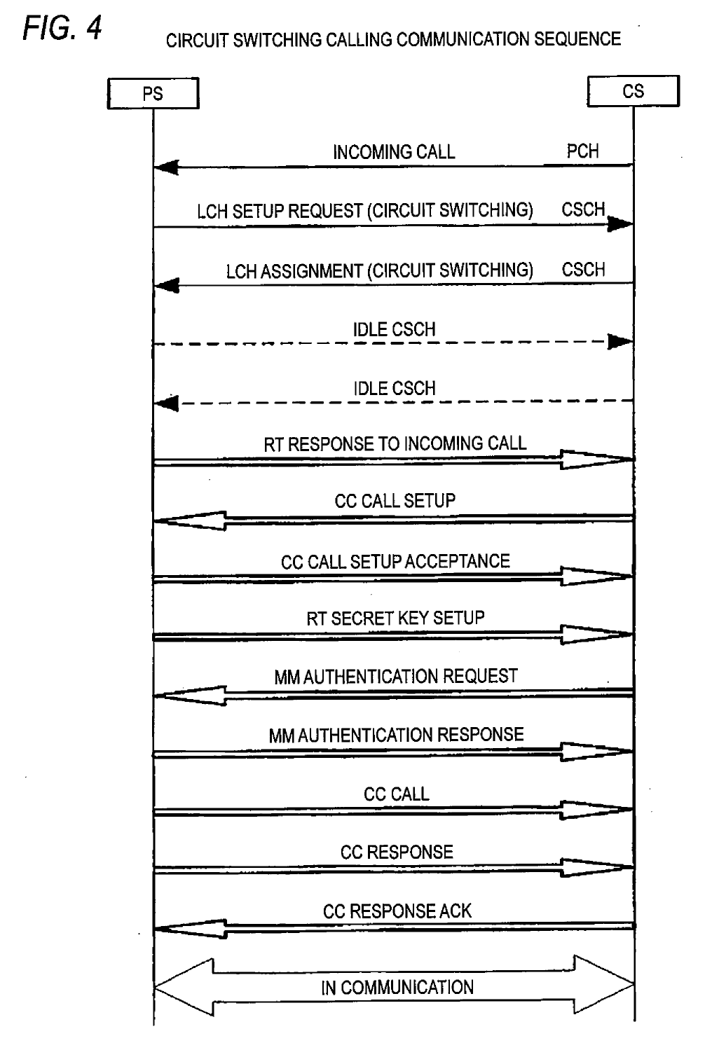

FIG. 4 is a diagram illustrating a communication sequence of a called party. The base station CS notifies an incoming call by sending an incoming call message PCH to the mobile station PS. The mobile station PS sets up a link channel in response to the incoming call message PCH. The mobile station PS sends a link channel (LCH) setup request to the base station CS. A circuit switching scheme or a packet switching scheme can be selected as the link scheme. When the communication object is voice data, a circuit switching subchannel CSCH is sent to request for the circuit switching scheme. The base station CS returns the circuit switching subchannel CSCH to the mobile station PS and notifies an assigned subchannel number to the mobile station PS (assignment of LCH). The mobile station PS sends an idle CSCH through the assigned subchannel. The base station CS confirms an uplink idle CSCH and returns an idle CSCH. The mobile station PS recognizes that the link is set up in the circuit switching scheme by a downlink CSCR, and enters a service channel setup phase.

After setting up the link channel, the mobile station PS sends an incoming call response message RT to the base station CS. The base station CS receiving the incoming call message RT generates a call setup message CC from the session initiation message in the SIP and sends the generated message to the mobile station PS. The mobile station PS receiving the call setup message CC returns a call setup acceptance message CC.

The mobile station PS notifies a secret key to the base station CS with a secret key setup message RT. The authentication server generates an authentication random number and notifies an authentication request message MM. The base station CS relays the authentication request message MM to the mobile station PS. The mobile station PS receiving the authentication request message MM makes a calculation of the authentication random number using its own authentication key, adds the calculation result to an authentication response message MM, and sends the resultant message to the base station CS. The authentication server verifies the calculation result included in the authentication response message MM relayed by the base station CS, starts a call release sequence when the calculation result is incorrect, and continuously performs the calling sequence when the calculation result is correct.

The mobile station PS sending the authentication response message MM sends a calling message CC to the base station CS. The base station CS sends the calling message to the network in the SIP when receiving the calling message CC. When the mobile station PS is hooked off after sending a response message CC, the mobile station PS notifies the call acceptance by sending the response message CC to the base station CS. The base station CS receiving the response message CC notifies the response state to the network in the SIP and sends a response ACK message CC to the mobile station PS. The mobile station PS is changed to an in-communication state in response to the response ACK message CC indicating the completion of link.

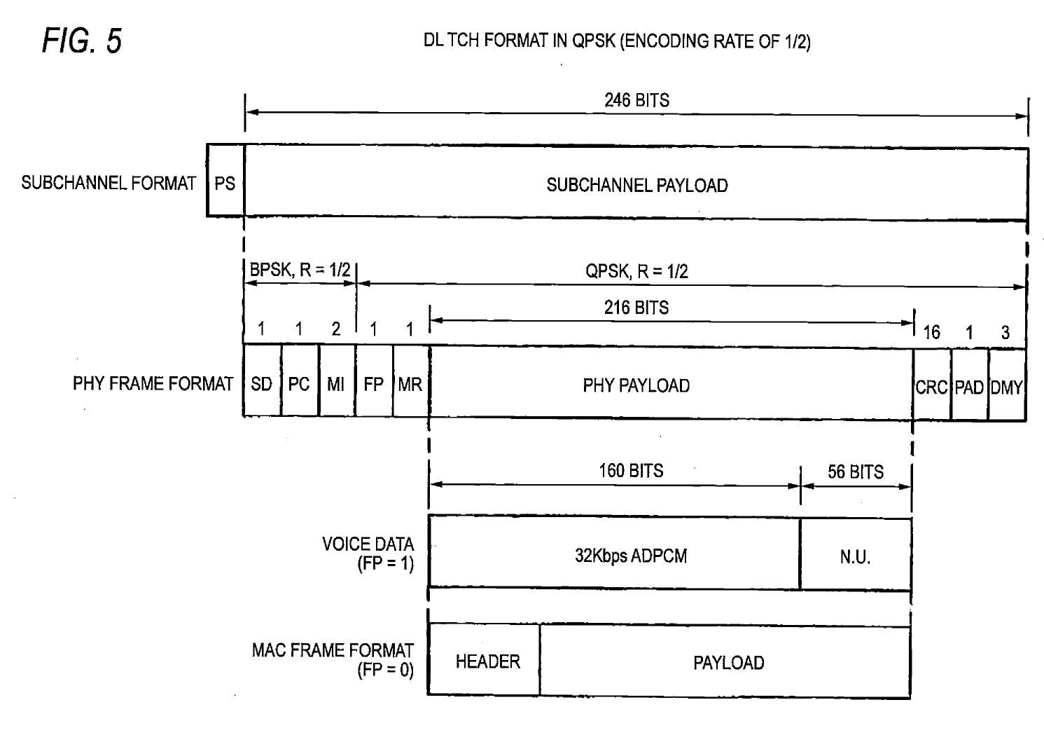

FIG. 5 is a diagram illustrating a frame format of the subchannels assigned to a mobile station, where downlink traffic channels of 32 Kbps-ADPCM voice call (QPSK) is shown. An FP (Free Protocol) field of a PHY (physical layer) frame represents a type of data included in a PHY (physical layer) payload. When the FP field represents no sequence (FP=1), the payload includes ADPCM data. When the FP field represents a MAC protocol (FP=0), the payload includes a MAC frame. The modulation scheme is based on the QPSK (encoding rate of 1/2) and an adaptive modulation is carried out in two modulation classes with the BPSK (encoding rate of 1/2) to reinforce a link budget. Specifically, the adaptive modulation of QPSK (encoding rate of 1/2) or BPSK (encoding rate of 1/2) is performed on the portion after the PHY (physical layer) payload and a fixed modulation of BPSK (encoding rate of 1/2) is performed on the portion before the PHY (physical layer) payload.

According to the above-mentioned embodiment, it is possible to optimally assign the subchannels according to the type of a call by changing the subchannel assignment procedure according to the type of a call. For example, when the type of a call is a voice communication, the MAP information necessary for the dynamic assignment is not required while assigning only the subchannel used in the voice communication. Accordingly, it is possible to assign the subchannel assigned as the anchor subchannel for the MAP information as a subchannel used in the voice communication or a subchannel used by another user. Since the voice communication can be made by only one subchannel, it is possible to improve the utilization efficiency of the traffic channels. By fixedly assigning the subchannels in the voice communication in advance, the subchannel interfering with another station is not assigned, which can occur in the dynamic assignment, thereby not causing the deterioration in voice quality.

1. A base station which communicates with mobile stations by an OFDMA scheme using subchannels, the base station comprising:
a channel assigning unit which assigns subchannels for communication to the mobile stations; and
a type acquiring unit which acquires a type of a call as a communication object,
wherein the channel assigning unit changes a subchannel assignment procedure for assigning the subchannels to the mobile stations according to the acquired type of the call.

2. The base station according to claim 1,
wherein when the acquired type of the call is a data communication, the channel assigning unit assigns a subchannel used in the data communication and a subchannel for specifying the subchannel every predetermined timing, and
wherein when the acquired type of the call is a voice communication, the channel assigning unit assigns only a subchannel used in the voice communication.

3. The base station according to claim 2,
wherein the channel assigning unit fixedly assigns the subchannel used in the voice communication to a mobile station when the acquired type of the call is the voice communication.

4. The base station according to claim 2,
wherein the channel assigning unit does not change the assigned subchannel used in the voice communication from a start of the communication to an end thereof when the acquired type of the call is the voice communication.

5. A communication method for performing a communication between mobile stations and a base station by an OFDMA scheme using subchannels, the method comprising:
a step of acquiring a type of a call as a communication object; and
a channel assigning step of changing a subchannel assignment procedure for assigning the subchannels to the mobile stations according to the acquired type of the call.

6. The communication method according to claim 5,
wherein when the acquired type of the call is a data communication, the channel assigning step assigns a subchannel used in a data communication and a subchannel for specifying the subchannel every predetermined timing, and
wherein when the acquired type of the call is a voice communication, the channel assigning step assigns only a subchannel used in the voice communication.

7. The communication method according to claim 6,
wherein the channel assigning step fixedly assigns the subchannel used in the voice communication to a mobile station when the acquired type of a call is the voice communication.

8. The communication method according to claim 6,
wherein the channel assigning step does not change the assigned subchannel used in the voice communication from a start of the communication to an end thereof when the acquired type of the call is the voice communication.
